(19) United States
(12) Patent Application Publication
(10) Pub. No.: US 2018/0195909 A1
(43) Pub. Date: Jul. 12, 2018

(54) ANTI-INTERFERENCE TEMPERATURE SIGNAL RECEIVING DEVICE AND SIGNAL PROCESSING METHOD

(71) Applicant: SHENZHEN HUAYUAN MICRO ELECTRONIC TECHNOLOGY CO., LTD., Shenzhen, Guangdong (CN)

(72) Inventors: Qiming Dong, Shenzhen, Guangdong (CN); Ning Wang, Shenzhen, Guangdong (CN); Yanlong Yao, Shenzhen, Guangdong (CN); Shaokan Liu, Shenzhen, Guangdong (CN); Huaxing Cai, Shenzhen, Guangdong (CN); Jian Wang, Shenzhen, Guangdong (CN); Zhongping Li, Shenzhen, Guangdong (CN)

(21) Appl. No.: 15/741,060

(22) PCT Filed: Apr. 5, 2016
(86) PCT No.: PCT/CN2016/078432

§ 371 Date: Dec. 29, 2017

(30) Foreign Application Priority Data
Aug. 14, 2015 (CN) 201510502548.0

(51) Int. Cl. G01K 11/26; H04B 15/06

(52) U.S. Cl. CPC G01K 11/265; H04B 15/06

(57) ABSTRACT

An anti-interference temperature signal receiving device and signal processing method. The device comprises a digital signal processing chip, a transmitting phase-locked loop local oscillator, a fixed intermediate frequency oscillator, a first mixer, a first band-pass filter, a power amplifier, a transceiver module, a second band-pass filter, a low noise amplifier, a receiving phase-locked loop local oscillator, a second mixer, a receiving intermediate frequency filter, a second receiving local oscillator, a third mixer, and a power supply circuit. Because a first intermediate signal, has a frequency consistent with the reference signal frequency, it can be ensured that transmitting and receiving are performed at an identical frequency, while resolving a signal interference problem owing to a phase-locked loop characteristic and resulting in identical signal frequencies of a transmitting signal and a reference signal during synchronization.

### FIELD OF THE INVENTION

The present application relates to an intercrossed technical field covering radio frequency technology and surface acoustic wave technology, especially to an anti-interference temperature signal receiving device and a signal processing method thereof.

### BACKGROUND OF THE INVENTION

A temperature measurement system, which is designed based on principles and characteristics of surface acoustic wave (SAW) oscillator, generally utilizes identical receiving and transmitting frequency with different receiving and transmitting time periods. In principle, transceiving interference issues should have been avoided when the receiving and transmitting time periods are different, however, since receiving and transmitting local oscillator circuits utilize phase-locked hoop frequency synthesizer technology, a time interval from the time when the digital processing chipset transmits frequency to the time when the phase-locked hoop local oscillator outputs a working frequency is at least 500 microseconds, furthermore, it would take 20 microseconds for the receiving end to receive data, which would make a transmitting of a receiving frequency signal and a transmitting of the next transmitting frequency signal basically synchronous. The transmitting and receiving frequencies may interfere with each other, which would make the measured temperature inaccurate.

### SUMMARY OF THE INVENTION

In order to overcome the technical problem that the transmitting and receiving frequencies may interfere with each other, the application provides an anti-interference temperature signal receiving device and a signal processing method thereof.

The anti-interference temperature signal receiving device includes a digital signal processing chip, a transmitting phase-locked loop local oscillator, a fixed intermediate frequency oscillator, a first mixer, a first band-pass filter, a power amplifier, a transceiver module, a second band-pass filter, a low noise amplifier, a receiving phase-locked loop local oscillator, a second mixer, a receiving intermediate frequency filter, a second receiving local oscillator, a third mixer, and a power supply circuit, wherein:

the digital signal processing chip is configured to generate a transmitting signal and transmit the transmitting signal to the transmitting phase-locked loop local oscillator, generate a reference signal and transmit the reference signal to the receiving phase-locked loop local oscillator, and process a third intermediate signal to obtain temperature data;

the transmitting phase-locked loop local oscillator is configured to receive and process the transmitting signal to obtain a stable transmitting signal;

the fixed intermediate frequency oscillator is configured to generate an intermediate frequency signal and transmit the intermediate frequency signal to the first mixer;

the first mixer is configured to mix the stable transmitting signal with the intermediate frequency signal to obtain a first intermediate signal, wherein the frequency of the first intermediate signal is consistent with the frequency of the reference signal;

a first band-pass filter is configured to filter the first intermediate signal;

the power amplifier is configured to amplify the signal filtered by the first band-pass filter;

the transceiver module is configured to transmit an actuating signal which is a signal amplified by the power amplifier, and receive a response signal returned by a sensor;

the second band-pass filter is configured to filter the response signal;

the low-noise amplifier is configured to amplify a signal filtered by the second band-pass filter;

the receiving phase-locked loop local oscillator is configured to receive and process the reference signal to obtain a stable reference signal;

the second mixer is configured to mix the signal amplified by the low-noise amplifier with the stable reference signal to obtain a second intermediate signal;

the receiving intermediate frequency filter is configured to filter the second intermediate signal;

the second receiving local oscillator is configured to generate low-frequency signal and transmit the low-frequency signal to the third mixer;

the third mixer is configured to mix a signal filtered by the receiving intermediate frequency filter with the low-frequency signal to obtain a third intermediate signal;

the power supply circuit is configured to provide power to the device.

A signal processing method for the anti-interference temperature signal receiving device, the method includes:

a. transmitting an actuating signal
by the digital signal processing chip, transmitting a transmitting signal in advanced to the transmitting phase-locked loop local oscillator, wherein the frequency of the transmitting signal is higher or lower than a reference signal frequency;
by the transmitting phase-locked loop local oscillator, processing the transmitting signal to generate a stable transmitting signal;
by the first mixer, mixing the stable transmitting signal with the intermediate frequency signal generated by the fixed intermediate frequency oscillator to generate a first intermediate signal which has a frequency consistent with the reference signal frequency;
by the first band-pass filter, filtering the first intermediate signal to generate a first filtered intermediate signal;
by the transceiver module, transmitting the first filtered intermediate signal as the actuating signal which has been amplified by the power amplifier;

b. receiving and processing a response signal and obtaining temperature data
by the transceiver module, receiving the response signal returned by a sensor; at the same time, by the digital signal processing chip, transmitting the reference signal to the receiving phase-locked loop local oscillator;
by the second band-pass filter, filtering the response signal to obtain a filtered response signal;
by the low-noise amplifier, amplifying the filtered response signal to obtain a first amplified intermediate signal;
by the second mixer, mixing the first amplified intermediate signal with the reference signal to generate a second intermediate signal;
by the receiving intermediate frequency filter, filtering the second intermediate signal to generate a second filtered intermediate signal;
by the third mixer, mixing the second filtered intermediate signal and a low frequency signal transmitted by the second local oscillator to generate a third intermediate signal;
by the digital signal processing chip, processing the third intermediate signal, and obtaining the temperature data

In the application, the transmitting signal frequency transmitted in advanced by the digital signal processing chip to the transmitting phase-locked loop local oscillator is higher or lower than a reference signal frequency. The transmitting signal is processed by the transmitting phase-locked loop local oscillator to obtain a stable transmitting signal; the stable transmitting signal is mixed by the first mixer with the intermediate frequency signal generated by the fixed intermediate frequency signal to obtain a first intermediate signal, wherein the frequency of the first intermediate signal is consistent with the frequency of the reference signal; it can be ensured that the temperature signal receiver works properly, and interference issues which may occur when transmitting and receiving signal are basically synchronous owing to a phase-locked loop characteristic can be avoided, which can increase accuracy of a temperature data measurement.

### BRIEF DESCRIPTION OF THE DRAWINGS

In order to make the technical schemes of the embodiments of the present application or the prior art clearer, accompanying drawings intended to describe the embodiment or the prior art should be briefly described. Obviously, the drawings below are merely some of the embodiments of the present application, those skilled in the art may obtain other embodiments in the light of the drawings below without further creative works.

FIG. 1 is a structure block view of the anti-interference temperature signal receiving device;

FIG. 2 is a structure view of the transceiver module of the anti-interference temperature signal receiving device.

In which,

1: transceiver switch

2: antenna selection switches

3: antenna

2-1: first antenna selection switch

2-2: second antenna selection switch

2-3: third antenna selection switch.

### DETAILED DESCRIPTION OF THE PREFERRED EMBODIMENT

Technical solutions in the embodiments of the present application will be described clearly and thoroughly hereinafter with reference to the accompanying drawings. Apparently, the embodiments described herein are merely parts of but not exclusive embodiments of the present application. All alternative embodiments obtained by those skilled in the art based on the embodiments of the present application without creative works shall fall within the protection scope of the present application.

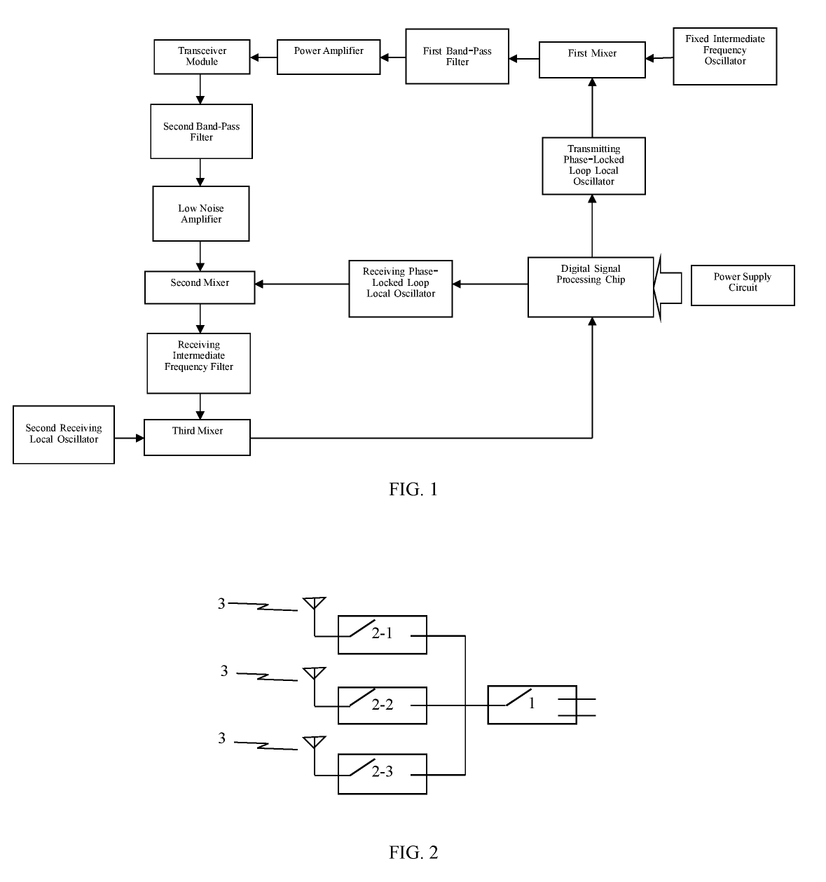

As shown in FIG. 1, the anti-interference temperature signal receiving device includes a digital signal processing chip, a transmitting phase-locked loop local oscillator, a fixed intermediate frequency oscillator, a first mixer, a first band-pass filter, a power amplifier, a transceiver module, a second band-pass filter, a low noise amplifier, a receiving phase-locked loop local oscillator, a second mixer, a receiving intermediate frequency filter, a second receiving local oscillator, a third mixer, and a power supply circuit. During the process of transmitting an actuating signal: a transmitting signal is transmitted in advanced by the digital signal processing chip to the transmitting phase-locked loop local oscillator, wherein the frequency of the transmitting signal is higher or lower than a reference signal frequency. The transmitting signal will be stable after processed by the transmitting phase-locked loop local oscillator. The stable transmitting signal, as well as an intermediate frequency signal generated by the fixed intermediate frequency oscillator would be transmitted to the first mixer. The first mixer will have the stable transmitting signal and the intermediate frequency signal transmitted by the fixed intermediate frequency oscillator mixed and generate a first intermediate signal which has a frequency consistent with the reference signal frequency. The first intermediate signal will be filtered by the band-pass filter to generate a first filtered intermediate signal which will be amplified by the power amplifier to generate a first amplified intermediate signal which would be transmitted as the actuating signal through the transceiver module. For example, the transmitting signal transmitted by the digital signal processing chip to the transmitting phase-locked loop local oscillator is a signal with a frequency of 755.5 MHZ; the intermediate frequency signal generated by the fixed intermediate frequency oscillator is a signal with a frequency of 320 MHZ; the first intermediate signal mixed by the transmitting signal and the intermediate frequency signal through the first mixer is a signal of a frequency of 435.5 MHZ, the reference signal transmitted by the digital signal processing chip to the receiving phase-locked loop local oscillator is a signal with a frequency of 435.5 MHZ, therefore, the frequency of the first intermediate signal is consistent with the reference signal frequency, which ensures that the transmitting and receiving are of identical frequency. During the process of receiving and processing a response signal and obtaining a temperature signal: the response signal returned by a sensor will be received by the transceiver module, transmitted to and filtered by the second band-pass filter to generate a filtered response signal which is a frequency signal with a bandwidth. After amplified by the low noise amplifier, the filtered response signal will be mixed with the reference signal transmitted by the digital signal processing chip to the receiving phase-locked loop local oscillator through the second mixer to generate a second intermediate signal which will be filtered by the receiving intermediate frequency filter to generate a second filtered intermediate signal. The second filtered intermediate signal and a low frequency signal transmitted by the second local oscillator are mixed by the third mixer to generate a third intermediate signal which is further transmitted to the digital signal processing chip for analysis and processing, obtaining the temperature data. The power supply circuit provides power for the whole anti-interference temperature signal receiving device.

As shown in FIG. 2, the transceiver module disclosed herein includes a transceiver switch 1, antenna selection switches 2 and an antenna 3. The antenna selection switches include a first antenna selection switch 2-1, a second antenna selection switch 2-2 and a third antenna selection switch 2-3. The number of the antenna selection switches is more than 3. The transceiver switch 1 is in parallel with multiple antenna selection switches for receiving different response signal. In order to select transceiving directions, the transceiver switch 1 is selected as a two-way control switch, and the antenna selection switches 2 are selected as one-way switches. Access for transmitting signal is different from that for receiving signal; the number of the antenna 3 is at least one.

The transmitting signal frequency transmitted in advanced by the digital signal processing chip to the transmitting phase-locked loop local oscillator is higher or lower than a reference signal frequency. Because a first intermediate signal, generated by the first mixer mixing an intermediate frequency signal generated by the fixed intermediate frequency oscillator and a stable transmitting signal output by the transmitting phase-locked loop local oscillator, has a frequency consistent with the reference signal frequency, it can be ensured that transmitting and receiving are performed at an identical frequency, while resolving a signal interference problem that occurs when the digital signal processing chip transmits the transmitting signal to the transmitting phase-locked loop local oscillator, and owing to a phase-locked loop characteristic and resulting in identical signal frequencies of a transmitting signal and a reference signal during synchronization. Therefore, the invention can increase accuracy of a temperature data measurement.

The embodiments described above are merely preferred embodiments, but not intended to limit the application. Any modifications, alternatives or improvements made within the principle and spirit of the present application should be interpreted as falling within the protection scope of the present application.

What is claimed is:

1. An anti-interference temperature signal receiving device comprising a digital signal processing chip, a transmitting phase-locked loop local oscillator, a fixed intermediate frequency oscillator, a first mixer, a first band-pass filter, a power amplifier, a transceiver module, a second band-pass filter, a low noise amplifier, a receiving phase-locked loop local oscillator, a second mixer, a receiving intermediate frequency filter, a second receiving local oscillator, a third mixer, and a power supply circuit, wherein,
the digital signal processing chip is configured to generate a transmitting signal and transmit the transmitting signal to the transmitting phase-locked loop local oscillator, generate a reference signal and transmit the reference signal to the receiving phase-locked loop local oscillator, and process a third intermediate signal to obtain temperature data;
the transmitting phase-locked loop local oscillator is configured to receive and process the transmitting signal to obtain a stable transmitting signal;
the fixed intermediate frequency oscillator is configured to generate an intermediate frequency signal and transmit the intermediate frequency signal to the first mixer;
the first mixer is configured to mix the stable transmitting signal with the intermediate frequency signal to obtain a first intermediate signal, wherein the frequency of the first intermediate signal is consistent with the frequency of the reference signal;
a first band-pass filter is configured to filter the first intermediate signal;
the power amplifier is configured to amplify the signal filtered by the first band-pass filter;
the transceiver module is configured to transmit an actuating signal which is a signal amplified by the power amplifier, and receive a response signal returned by a sensor;
the second band-pass filter is configured to filter the response signal;
the low-noise amplifier is configured to amplify a signal filtered by the second band-pass filter;
the receiving phase-locked loop local oscillator is configured to receive and process the reference signal to obtain a stable reference signal;
the second mixer is configured to mix the signal amplified by the low-noise amplifier with the stable reference signal to obtain a second intermediate signal;
the receiving intermediate frequency filter is configured to filter the second intermediate signal;
the second receiving local oscillator is configured to generate low-frequency signal and transmit the low-frequency signal to the third mixer;
the third mixer is configured to mix a signal filtered by the receiving intermediate frequency filter with the low-frequency signal to obtain a third intermediate signal;
the power supply circuit is configured to provide power to the device.

2. The device of claim 1, wherein the transceiver module comprises a transceiver switch, antenna selection switches and an antenna.

3. The device of claim 2, wherein the transceiver switch is a two-way control switch, and the antenna selection switches are one-way switches.

4. The device of claim 2, wherein at least one antenna is provided.

5. A signal processing method for the anti-interference temperature signal receiving device, wherein the method comprises:
a. transmitting an actuating signal
by the digital signal processing chip, transmitting a transmitting signal in advanced to the transmitting phase-locked loop local oscillator, wherein the frequency of the transmitting signal is higher or lower than a reference signal frequency;
by the transmitting phase-locked loop local oscillator, processing the transmitting signal to generate a stable transmitting signal;
by the first mixer, mixing the stable transmitting signal with the intermediate frequency signal generated by the fixed intermediate frequency oscillator to generate a first intermediate signal which has a frequency consistent with the reference signal frequency;
by the first band-pass filter, filtering the first intermediate signal to generate a first filtered intermediate signal;
by the transceiver module, transmitting the first filtered intermediate signal as the actuating signal which has been amplified by the power amplifier;
b. receiving and processing a response signal and obtaining temperature data
by the transceiver module, receiving the response signal returned by a sensor;
at the same time, by the digital signal processing chip, transmitting the reference signal to the receiving phase-locked loop local oscillator;
by the second band-pass filter, filtering the response signal to obtain a filtered response signal;
by the low-noise amplifier, amplifying the filtered response signal to obtain a first amplified intermediate signal;
by the second mixer, mixing the first amplified intermediate signal with the reference signal to generate a second intermediate signal;
by the receiving intermediate frequency filter, filtering the second intermediate signal to generate a second filtered intermediate signal;
by the third mixer, mixing the second filtered intermediate signal and a low frequency signal transmitted by the second local oscillator to generate a third intermediate signal;
by the digital signal processing chip, processing the third intermediate signal, and obtaining the temperature data.
